(19) United States
(12) Patent Application Publication
(10) Pub. No.: US 2019/0295387 A1
(43) Pub. Date: Sep. 26, 2019

(54) MERCHANDISE SECURITY SYSTEMS

(71) Applicant: InVue Security Products Inc., Charlotte, NC (US)

(72) Inventors: Jeffrey A. Grant, Charlotte, NC (US); Daniel G. Dugas, Charlotte, NC (US); David N. Berglund, Indian Trail, NC (US); Kyle Baker, Waxhaw, NC (US); Jonathon D. Phillips, Fort Mill, SC (US); Glen A. Kruse, Waxhaw, NC (US)

(21) Appl. No.: 16/440,580

(22) Filed: Jun. 13, 2019

Related U.S. Application Data
(63) Continuation of application No. 15/742,291, filed on Jan. 5, 2018, now abandoned.
(60) Provisional application No. 62/190,092, filed on Jul. 8, 2015.
(60) Provisional application No. 62/190,098, filed on Jul. 8, 2015.
(60) Provisional application No. 62/190,110, filed on Jul. 8, 2015.
(60) Provisional application No. 62/197,888, filed on Jul. 28, 2015.

(51) Int. Cl. G08B 13/14; E05B 73/00

(52) U.S. Cl. CPC G08B 13/1418; E05B 73/0082; E05B 73/0005; G08B 13/1445; G08B 13/1409

(57) ABSTRACT

Embodiments of the present invention are directed to security systems for securing an item of merchandise from theft. For example, the security system may include a sensor configured to be secured to the item of merchandise and a base configured to removably support the sensor and the item of merchandise thereon. The security system also includes a cable configured to be connected to the sensor and a swivel switch at one of the cable for operably engaging the item of merchandise. The item of merchandise may be configured to rotate relative to the swivel switch, and actuation of the swivel switch may be indicative of a security event.

### CROSS REFERENCE TO RELATED APPLICATIONS

This application is a continuation of U.S. application Ser. No. 15/742,291, filed on Jul. 7, 2016, which is a 371 national stage entry of International Application No. PCT/US2016/041303, filed on Jul. 7, 2016, which claims the benefit to priority of U.S. Provisional Patent Application No. 62/190,092 filed on Jul. 8, 2015, U.S. Provisional Patent Application No. 62/190,098 filed on Jul. 8, 2015, U.S. Provisional Patent Application No. 62/190,110 filed on Jul. 8, 2015, and U.S. Provisional Patent Application No. 62/197,888 filed on Jul. 28, 2015, the entire disclosures of which are incorporated herein by reference.

### BACKGROUND OF THE INVENTION

Embodiments of the present invention relate generally to security systems for protecting items of merchandise, such as consumer electronics products, from theft and/or unauthorized removal.

It is common practice for retailers to provide demonstration models of consumer electronics products, such as handheld devices, tablets, and laptop computers, so that a potential purchaser may examine the product more closely and test the operation of its features. A working demonstration model, however, increases the possibility that the demonstration model will be stolen or removed from the display area by an unauthorized person. As a result, demonstration models of consumer electronics products are typically protected by a security system that permits a potential purchaser to examine and operate the product, while reducing the likelihood that the demonstration model will be stolen or removed from the display area.

### BRIEF SUMMARY

Embodiments of the present invention are directed to security systems for securing an item of merchandise from theft. For example, the security system may include a sensor configured to be secured to the item of merchandise. The security system also includes a cable configured to be connected to the sensor and a swivel switch at one of the cable for operably engaging the item of merchandise. The item of merchandise may be configured to rotate relative to the swivel switch, and actuation of the swivel switch may be indicative of a security event.

In another embodiment, the security system may include a sensor and at least one bracket arm configured to be releasably secured to the sensor and the item of merchandise. The security system also includes a first cable configured to be secured to the sensor. The security system further includes a second cable configured to be secured to the sensor and to removably engage an input port on the item of merchandise. The bracket arm is configured to be removably attached to the sensor such that the sensor and the first and second cables are configured to be removed from the bracket arm while the bracket arm remains attached to the item of merchandise.

In one embodiment, the security system may include a sensor and at least one bracket arm configured to be releasably secured to the sensor and the item of merchandise. The security system also includes a cable configured to be secured to the sensor and to removably engage an input port on the item of merchandise. The bracket arm is configured to be removably attached to the sensor such that the sensor and the cable are configured to be removed from the bracket arm while the bracket arm remains attached to the item of merchandise.

In one embodiment, the security system may include at least one item of merchandise and at least one sensor configured to be secured to the item of merchandise. The security system also includes at least one cable configured to be connected to the sensor. The security system further includes a central controller configured to communicate directly with the item of merchandise for interacting with the item of merchandise.

### BRIEF DESCRIPTION OF THE DRAWINGS

FIG. 1 is a perspective view of a security system according to one embodiment of the present invention.

FIG. 2 is a rear perspective view of the security system shown in FIG. 1.

FIG. 3 is a perspective view of the security system shown in FIG. 1 showing the item of merchandise lifted off of the base.

FIG. 4 is a bottom perspective view of a sensor and an item of merchandise according to one embodiment of the present invention.

FIG. 5 is a front view of a sensor according to one embodiment of the present invention.

FIG. 6 is a side cross-sectional view of a security system according to one embodiment of the present invention.

FIG. 7 is a side cross-sectional view of a security system according to another embodiment of the present invention.

FIG. 8 is a perspective view of a security system according to one embodiment of the present invention.

FIG. 9 is a perspective view of a security system according to one embodiment of the present invention.

FIG. 10 is a rear perspective view of the security system shown in FIG. 9.

FIG. 11 is a perspective view of the security system shown in FIG. 9 showing the item of merchandise lifted off of the base.

FIG. 12 is a perspective view of a security system according to one embodiment of the present invention.

FIG. 13 is a perspective view of the security system shown in FIG. 13 showing the item of merchandise lifted off of the base.

FIG. 14 is a front view of a sensor supported on a base according to one embodiment of the present invention.

FIG. 15 is an exploded view of a sensor according to one embodiment of the present invention.

FIG. 16 is a partially assembled view of the sensor shown in FIG. 15.

FIG. 17 is a partially assembled view of the sensor shown in FIG. 15.

FIG. 18 is a fully assembled view of the sensor shown in FIG. 15.

FIG. 19 is a top view of a sensor according to one embodiment of the present invention.

FIG. 20 is a perspective view of the sensor shown in FIG. 19 with the swivel removed from the sensor base.

FIG. 21 is a perspective view of the swivel shown in FIGS. 19 and 20.

FIG. 22 is an exploded view of a base according to one embodiment of the present invention.

FIG. 23 is a fully assembled view of the base shown in FIG. 22.

FIG. 24 is a schematic showing information regarding a plurality of items of merchandise.

FIG. 25 is a schematic showing information regarding an item of merchandise.

### DETAILED DESCRIPTION OF EMBODIMENTS OF THE INVENTION

Referring to the accompanying figures wherein identical reference numerals denote the same elements throughout the various views, the attached figures illustrate embodiments of security systems according to the present invention for protecting an item of merchandise against theft or unauthorized removal. The item of merchandise may be any item, including any number of consumer electronics products (e.g. hand-held device, cellular phone, smart phone, tablet, laptop computer, camera, etc.). The security systems described herein are operable for securing the item of merchandise against theft or authorized removal, while at the same time permitting a potential purchaser to closely examine and operate the item of merchandise in a display area. The security system permits a potential purchaser to examine and test the item of merchandise, while reducing the likelihood that the item of merchandise will be stolen or removed from the display area by an unauthorized person. The systems shown and described herein are suitable for securing an item of merchandise in a residential or commercial environment, as well as a retail environment, and furthermore, is not intended to be limited to use only as a security display device for protecting against theft and/or unauthorized removal.

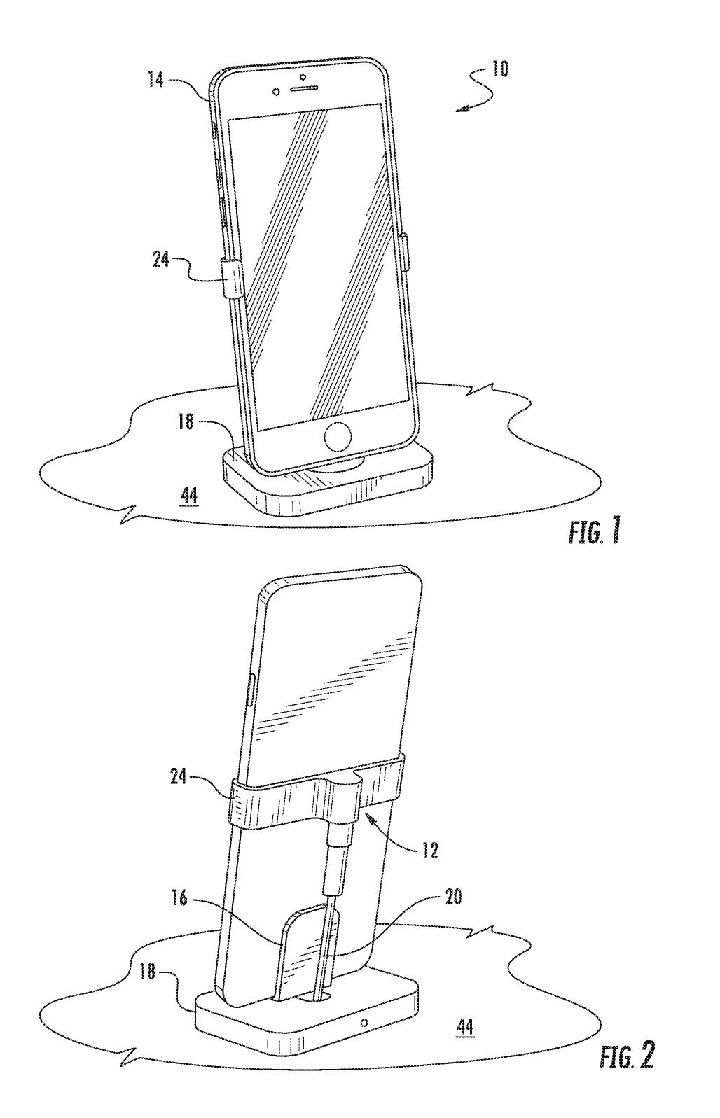

According to one embodiment shown in FIG. 1, the security system 10 generally comprises a sensor 12 configured to be coupled to an item of merchandise 14. The security system may also include a base 18 that is configured to removably support the sensor 12 and the item of merchandise 14 thereon. In some embodiments, the security system 10 also includes a cable 20 that is secured to the sensor 12 at one end and operably engaged with a recoiler 22 at an opposite end. As explained in further detail below, a sense circuit or loop may be defined through the cable 20. As such, the sense loop may be used to detect various security events associated with the cable 20, such as either cable being cut, shorted, and/or disconnected. The base 18 and/or sensor 12 may be configured detect security events associated with the sensor and/or the item of merchandise 14, such as the item of merchandise being removed from the sensor.

In one embodiment, the security system 10 includes a sensor 12. The sensor 12 may be secured to the item of merchandise 14 using any desired technique, such as with an adhesive, one or more fasteners, and/or mechanical brackets. The sensor 12 may be configured to engage a swivel switch 47 as described in further detail below. As shown in FIGS. 1-3, the sensor 12 may include one or more bracket arms 24 configured to mechanically engage the item of merchandise 14. The sensor 12 and the bracket arm 24 may be attached to one another or may be an integrally formed component. The illustrated bracket arm 24 is configured to span the width of the item of merchandise 14 and engage opposing lateral edges. The ends of the bracket arm 24 may be curved to facilitate engagement with the opposing lateral edges of the item of merchandise 14. Thus, in some cases, the bracket arm 24 may be a single integrated component. Although the term “sensor” is used herein, it is understood that the sensor 12 may simply provide a mounting member for connection to the cable 20. Thus, the sensor 12 may not include any electronics, circuitry, and/or sensing functionality in some embodiments.

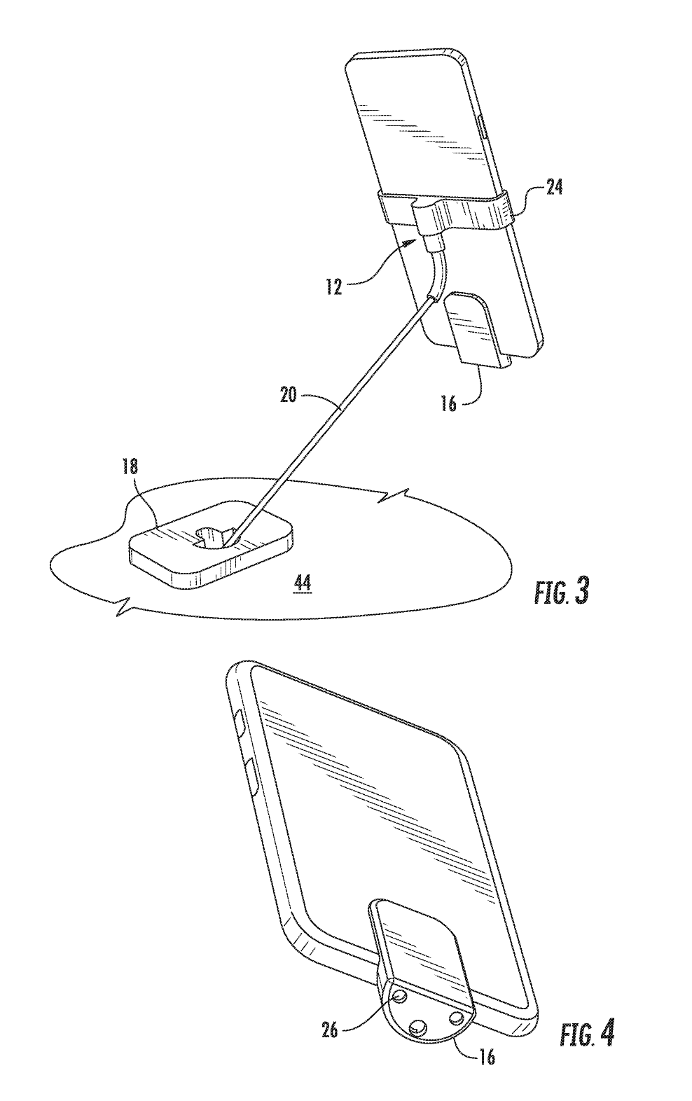

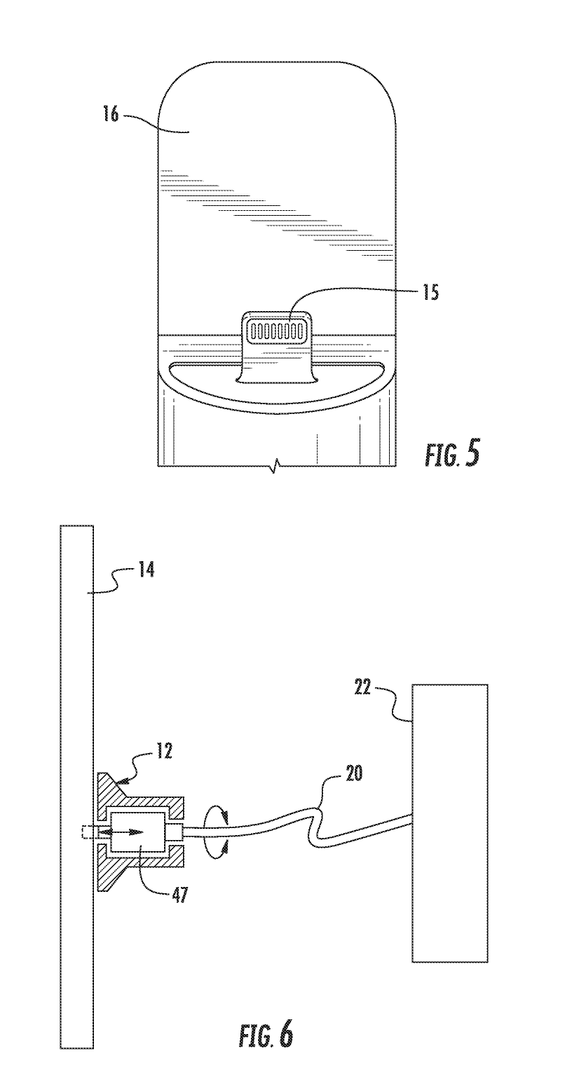

In one embodiment, the security system 10 includes a power adapter 16 with a connector 15 that is configured to electrically connect to an input jack of the item of merchandise 14 (see, e.g., FIG. 4). In one embodiment, the power adapter 16 may be secured to the item of merchandise 14, such as via an adhesive, and the connector 15 may be configured to be removably inserted into the input jack of the item of merchandise 14 (see, e.g., FIG. 5). For example, the connector 15 may be any suitable connector configured to engage a corresponding item of merchandise 14, such as a micro-USB connector or an Apple Lightning® connector. Each of the power adapter 16 and the base 18 may include one or more electrical contacts 26 for transferring power therebetween and to the item of merchandise 14. Thus, when the power adapter 16 is seated on the base 18, the electrical contacts 26 are configured to align and contact one another so that power may be transferred to the item of merchandise 14 for powering an internal battery or like power source. The base 18 may be electrically connected to a power source which is configured to provide power to the base. The power source may include a connector at a free end (e.g., a USB or like plug). The base 18 may be configured to facilitate power transfer from the external source of power to the electrical contacts 26 and to item of merchandise 14. Therefore, the item of merchandise 14 may be powered by power transferred thereto and may be used to charge a battery associated with the item of merchandise. It is understood that that other techniques may be employed to charge the item of merchandise 14, such as inductive charging.

The base 18 may be configured to be supported on a fixed support surface 44, such as a counter, shelf, fixture, or the like. Thus, the base 18 may be located entirely above the support surface 44. In other cases, the base 18 may be located below the support surface 44. In some instances, the base 18 may be configured to extend through an opening defined in the support surface 44. The base 18 may be secured to the support surface 44 using any desired technique such as an adhesive and/or fasteners. The base 18 may be operably engaged with a recoiler 22 as discussed above. As such, the cable 20 may be extended through the base 18 when the sensor 12 and the item of merchandise 14 are lifted from the base, and the cable may be retracted through the base when the sensor and the item of merchandise are returned to the base. The recoiler 22 may be spring biased in some embodiments such that the cable 20 is automatically retracted through the base 18. The base 18 may be supported on the support surface 44, while the recoiler may be positioned below the support surface. Furthermore, the base 18 may include a PCB, circuitry, or the like that is in electrical communication with the electrical contacts for transferring power to the item of merchandise 14 as discussed above. In some embodiments, the cable 20 may include one or more electrical conductors extending along the length of the cable. In some cases, the cable 20 may include a pair of conductors for defining a sense loop or circuit and conducting an electrical signal. In other cases, the cable 20 may include a single conductor, such as an electrical conductor, or optical conductor for conducting an optical signal (e.g., a fiber optic cable).

An end of cable 20 may be secured to the sensor 12. In one example, the cable 20 may be attached to the sensor 12 with a swivel switch 47 or like connector to allow for rotational movement between the sensor and the cable. The swivel switch 47 may provide only a mechanical swivel for rotational movement. The swivel switch 47 could be permanently attached to the sensor 12 or could be removably attached if desired. Thus, the swivel switch 47 may include a quick-disconnect feature that allows the end of the cable 20 to be readily detached from the sensor 12.

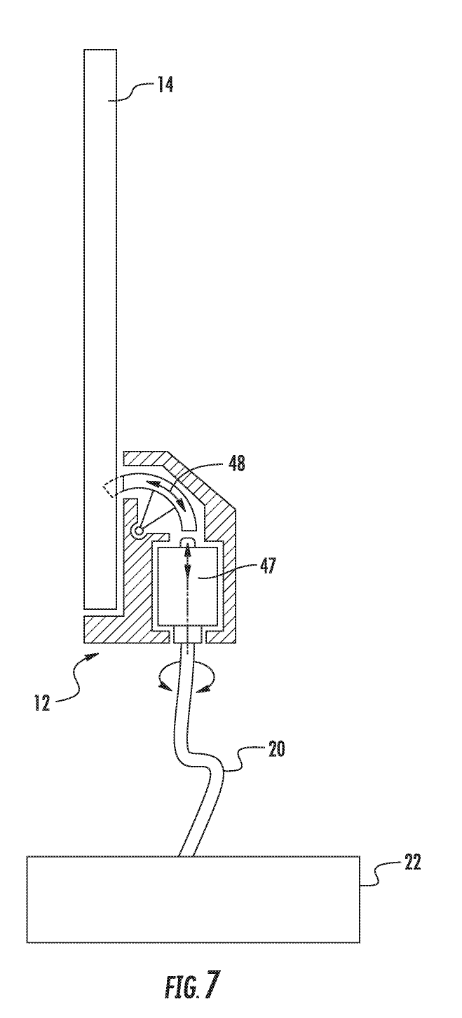

In some embodiments, the end of the cable 20 includes a swivel switch 47, such as a pressure or plunger switch. The swivel switch 47 may be configured to engage the item of merchandise 14 directly to thereby detect the presence of the item of merchandise. For example, FIG. 6 shows a swivel switch 47 configured to directly engage the item of merchandise 14. In other cases, the swivel switch 47 is operably engaged with a mechanism 48 for engaging the item of merchandise along a different axis than that of the switch. For example, FIG. 7 shows that the swivel switch 47 may be configured to engage a translating plunger 48 that is configured to translate relative to the switch in response to actuation of the switch. In this instance, the translating plunger 48 may be configured to directly engage the item of merchandise 14. Thus, the translating plunger 48 may facilitate operable engagement with the item of merchandise 14 along a different axis (e.g., curved or linear axis) than that of the switch. It is understood that various mechanisms may be provided for allowing the swivel switch 47 to operably engage the item of merchandise 14, which may include any combination of translational or rotational movement. For instance, a pivoting lever could be used in some embodiments. In other embodiments, the swivel switch 47 may be similar to that described in International Application No. PCT/US2015/027878, entitled Wearables Security Device and filed on Apr. 28, 2015, the entire contents of which are incorporated herein by reference. In any case, the swivel switch 47 may be configured to be actuated for closing a sense loop in one position and to be actuated to a second position whereby a sense loop is open and indicative of a security event. The cable 20 and the power adapter 16 may not be electrically connected to one another, and in some cases, the swivel switch 47 is only in mechanical engagement with the item of merchandise 14 where only a switch is opened or closed via operable engagement with the item of merchandise.

It is understood that the cable 20 may be any suitable cord, tether, or the like. In addition, the cable 20 may include one or more electrical conductors for transmitting electrical, security, and/or communication signals. In addition, the cable 20 may be a single strand, multi-strand, or braided. The cable 20 may be flexible to facilitate extension and retraction relative to the base 18, and in some embodiments, may be formed of a cut-resistant material. Furthermore, the cable 20 may have various cross sections, such as round or flat. In some embodiments, the security system 10 may not include a recoiler 22. Thus, the cable 20 could be a straight or coiled cable that is secured to the sensor 12 at one end and electrically connected to a base 18 or other device at an opposite end.

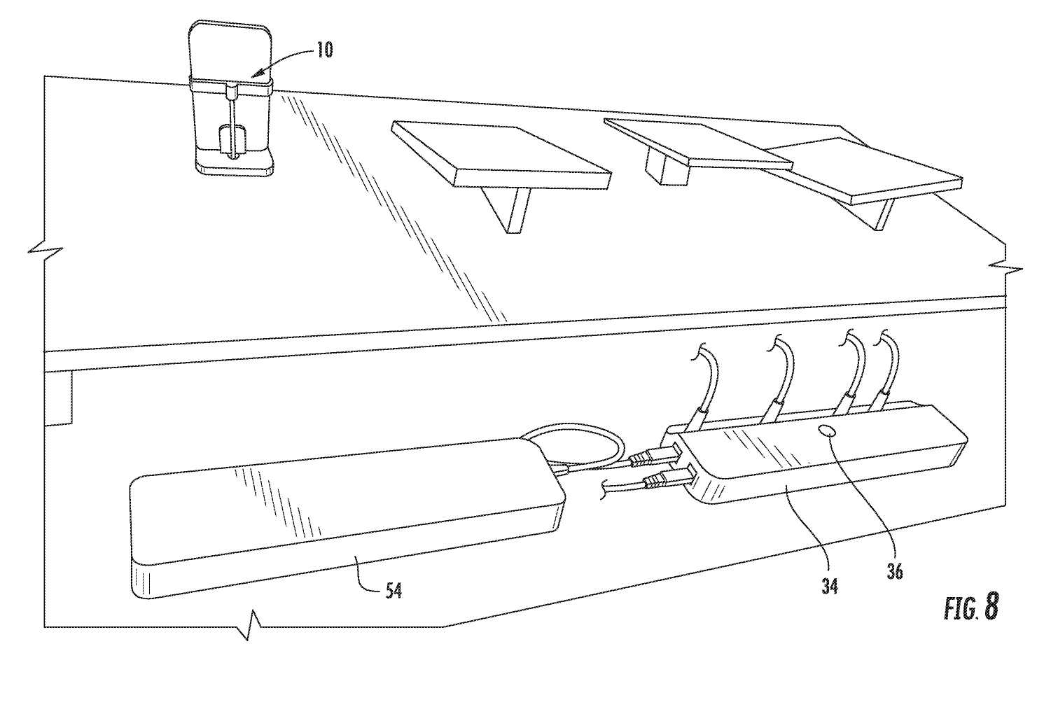

The cable 20 and/or recoiler 22 may be operably engaged with an alarm mechanism 34, such as a piezoelectric transducer, for generating an audible alarm in response to a security event (see, e.g., FIG. 8). In some cases, security systems 10 may be configured to operably engage the alarm mechanism 34. The base 18, alarm mechanism 34, or other device operably engaged with the alarm mechanism may include a port 36 that is configured to facilitate communication with a key. For example, the port 36 may facilitate wireless communication with a key for arming or disarming the security system 10. In one embodiment, the key is an infrared key configured to arm/disarm the alarm mechanism 34 with a unique identifying code. In some embodiments, the key is similar to the IR and IR2 keys manufactured by InVue Security Products Inc.

Various sensing techniques may be employed for determining whether the cable 20 has been cut or removed from the sensor 12 in an unauthorized manner. For example, the cable 20 may include a pair of electrical conductors that define a sense loop therethrough. Thus, should the sense loop be interrupted (e.g., by cutting or shorting the cable), the alarm mechanism 34 may detect the interruption and generate an alarm signal (e.g., an audible and/or a visible alarm).

Embodiments of the present invention may provide several advantages. For example, the mechanical swivel switch eliminates the need for electrical contacts and complicated electrical swivels that necessitate slip rings or like electrical components. In addition, a mechanical swivel switch may provide for lower pull resistance in the cable and lower friction in the recoiler due to a reduced number of conductors in the cable.

According to one embodiment shown in FIG. 9, the security system 100 generally comprises a sensor 12′ configured to be coupled to an item of merchandise 14. The security system may include a base 18′ that is configured to removably support the sensor and the item of merchandise thereon. In some embodiments, the security system 100 also includes a cable 20′ that is secured to the sensor 12′ at one end and operably engaged with a recoiler 22′ at an opposite end. The cable 20′ may include an adapter cable 16′ that is configured to electrically connect to the item of merchandise. As explained in further detail below, a sense circuit or loop may be defined through the cable 20′ and adapter cable 16′. As such, the sense loop may be used to detect various security events, such as either cable 20′ being cut, shorted, and/or disconnected. The base 18′ and/or sensor 12′ may be configured detect security events associated with the sensor and/or the item of merchandise 14, such as the item of merchandise being removed from the sensor.

In one embodiment, the sensor 12′ may be connected to an adapter cable 16′ having a connector 15′ that is configured to electrically connect to an input jack of the item of merchandise 14. In one embodiment, the adapter cable 16′ may be a portion at the end of the cable 20′ such that the cable is a continuous cable extending from the recoiler 22′ to the item of merchandise 14. In other embodiments, the adapter cable 16′ is a separate cable electrically connected to the cable 20′. The connector 15′ may be any suitable connector configured to engage a corresponding item of merchandise 14, such as a micro-USB connector or an Apple Lightning® connector. Thus, cable 20′ and the item of merchandise 14 may be electrically connected via the connector 15′. An end of cable 20′ may be secured to the sensor 12′.

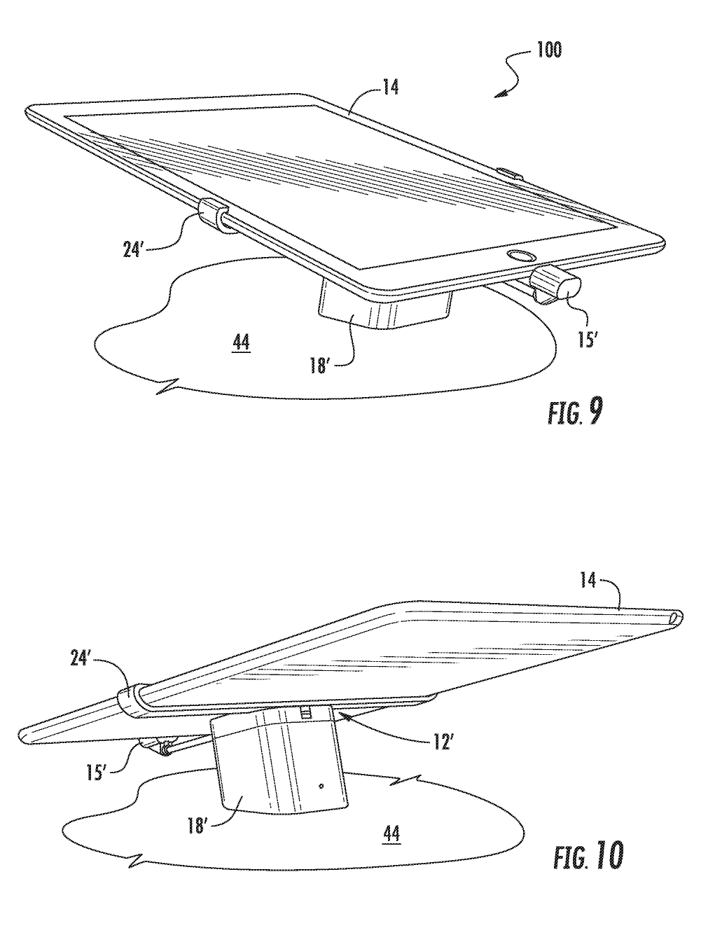

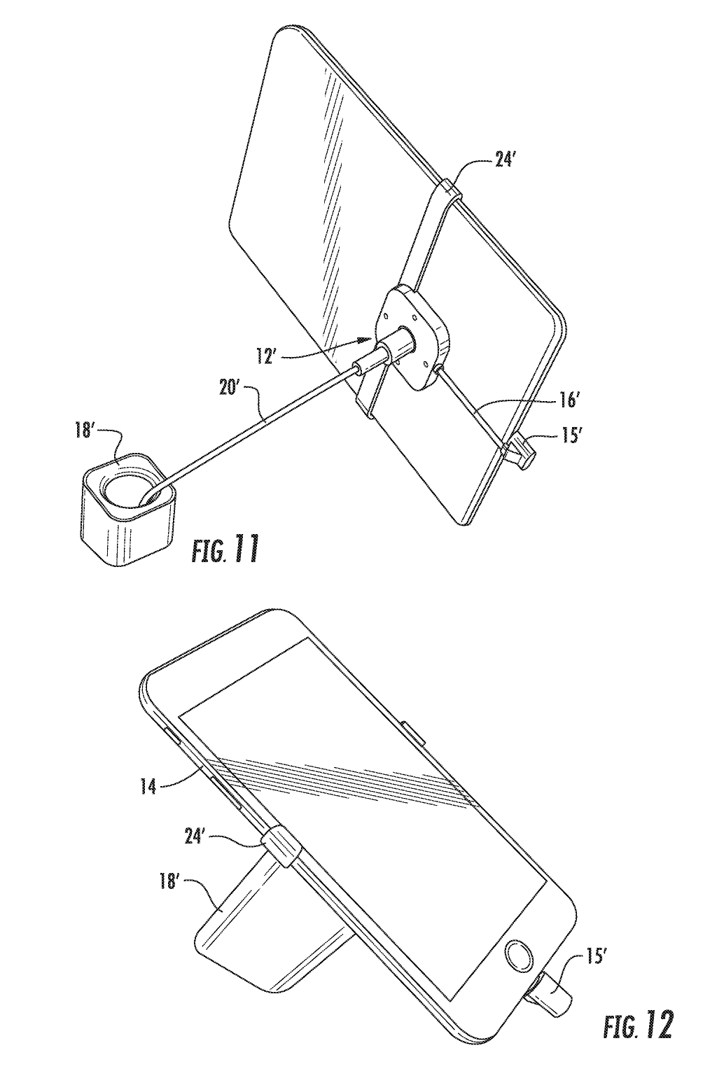

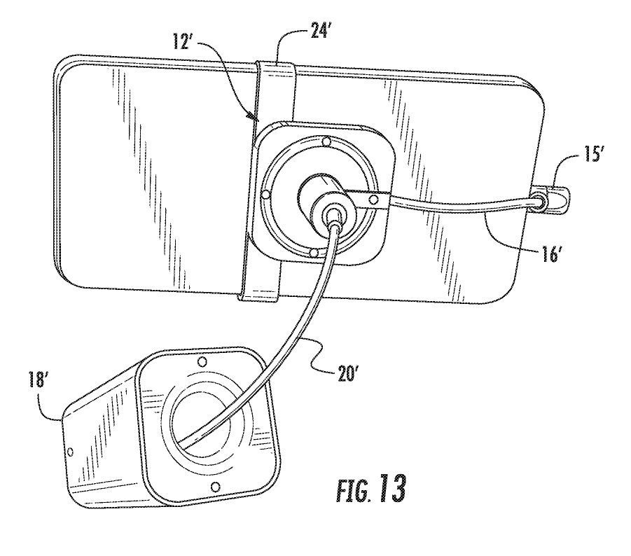

As shown in FIGS. 9-13, the sensor 12′ may include one or more bracket arms 24′ configured to mechanically engage the item of merchandise 14. The sensor 12′ and the bracket arm 24′ may be attached to one another or may be an integrally formed component. The illustrated bracket arm 24′ is configured to span the width of the item of merchandise 14 and engage opposing lateral edges. The ends of the bracket arm 24′ may be curved to facilitate engagement with the opposing lateral edges of the item of merchandise 14. Thus, in some cases, the bracket arm 24′ may be a single integrated component. Although the term “sensor” is used herein, it is understood that the sensor 12′ may simply provide a mounting member for connection to the cable 20′. Thus, the sensor may not include any electronics, circuitry, and/or sensing functionality in some embodiments.

The base 18′ may be configured to be supported on a fixed support surface 44, such as a counter, shelf, fixture, or the like. Thus, the base 18′ may be located entirely above the support surface 44. In other cases, the base 18′ may be located below the support surface 44. In some instances, the base 18′ may be configured to extend through an opening defined in the support surface 44. The base 18′ may be secured to the support surface 44 using any desired technique such as an adhesive and/or fasteners. The base 18′ may be operably engaged with a recoiler 22′ as discussed above. As such, the cable 20′ may be extended through the base 18′ when the sensor 12′ and the item of merchandise 14 are lifted from the base, and the cable may be retracted through the base when the sensor and the item of merchandise are returned to the base. The recoiler 22′ may be spring biased in some embodiments such that the cable 20′ is automatically retracted through the base 18′. The base 18′ may be supported on the support surface 44, while the recoiler may be positioned below the support surface (see FIG. 14). In some embodiments, the cable 20′ may include one or more electrical conductors extending along the length of the cable. In some cases, the cable 20′ may include a pair of conductors for defining a sense loop or circuit and conducting an electrical signal. In other cases, the cable 20′ may include a single conductor, such as an electrical conductor, or optical conductor for conducting an optical signal (e.g., a fiber optic cable).

It is understood that the cable 20′ may be any suitable cord, tether, or the like. In addition, the cable 20′ may include one or more electrical conductors for transmitting electrical, security, and/or communication signals. In addition, the cable 20′ may be a single strand, multi-strand, or braided. The cable 20′ may be flexible to facilitate extension and retraction relative to the base 18′, and in some embodiments, may be formed of a cut-resistant material. Furthermore, the cable 20′ may have various cross sections, such as round or flat. In some embodiments, the security system 100 may not include a recoiler 22′. Thus, the cable 20′ could be a straight or coiled cable that is secured to the sensor 12′ at one end and electrically connected to a base 18′ or other device at an opposite end.

The base 18′ and/or recoiler 22′ may be electrically connected to a power source. The base 18′ and/or recoiler 22′ may be configured to facilitate power transfer from the external source of power to the cable 20′ and to item of merchandise 14, via the adapter cable 16′ and connector 15′. Therefore, the item of merchandise 14 may be powered by power transferred thereto and may be used to charge a battery associated with the item of merchandise.

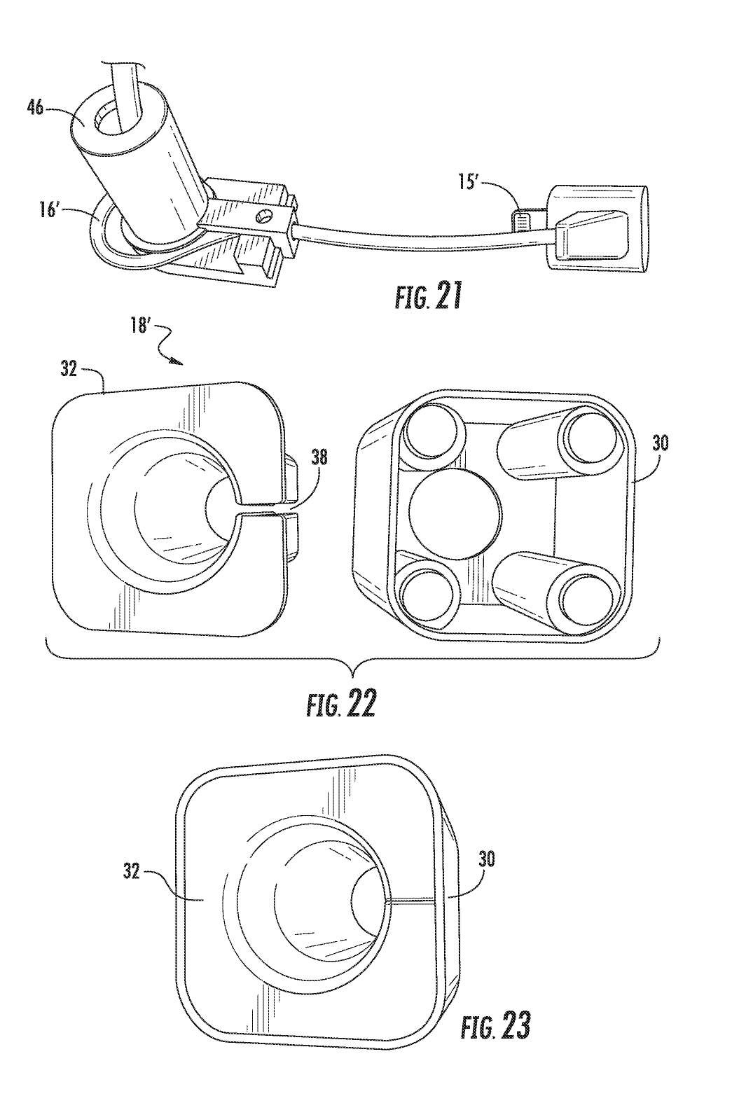

The base 18′ may include one or more modular components as shown in FIGS. 22-23. For instance, FIG. 22 shows that the base 18′ includes an outer member 30 and an inner member 32. The inner member 32 is configured to be received by the outer member 30. The inner member 32 may be removable from the outer member 30 for routing the sensor 12′ through the support surface 44 as explained in further detail below. Thus, a smaller diameter opening in the support surface 44 may be used, and a user is more easily able to route the sensor 12′ and cable 20′ through the support surface and the outer member 30. The inner member 32 may include a slot 38 for receiving the cable 20′ and thereby allowing the cable to be received through a central opening defined in each of the inner and outer members.

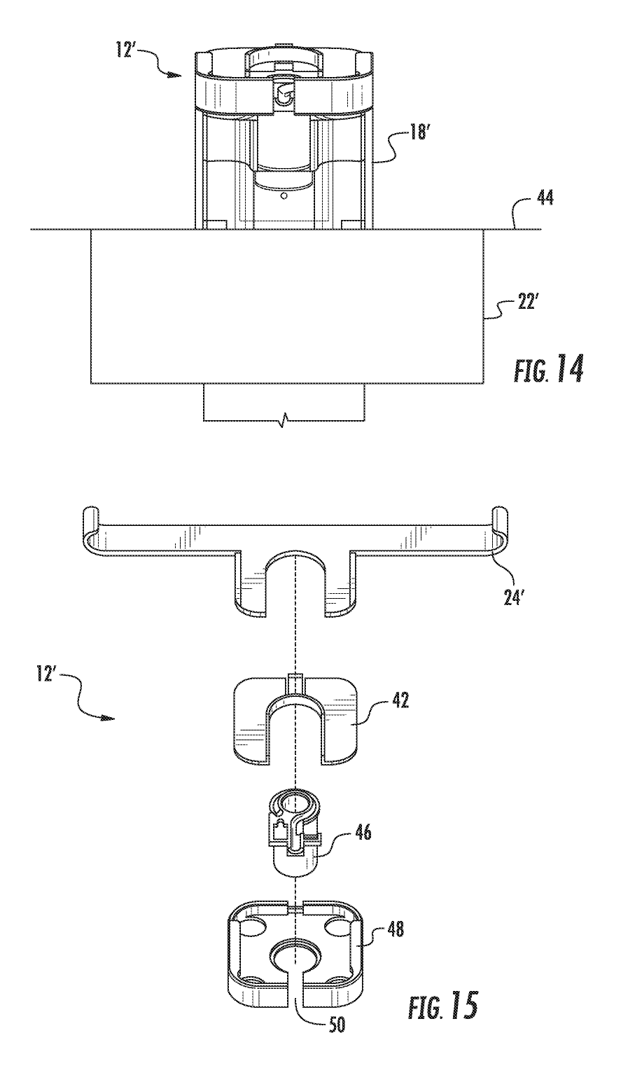

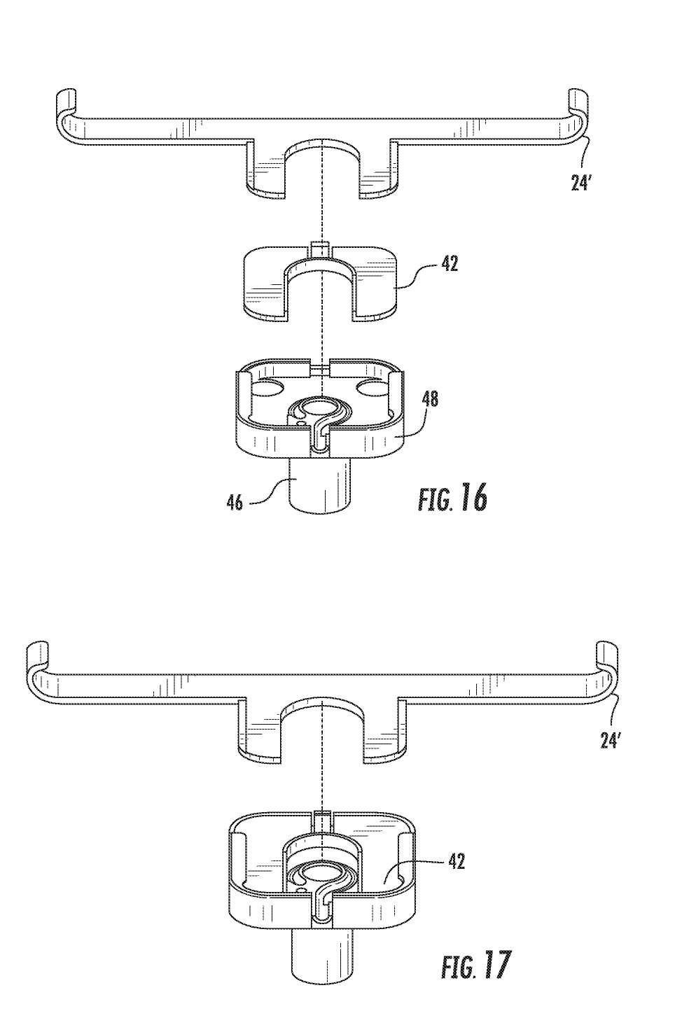

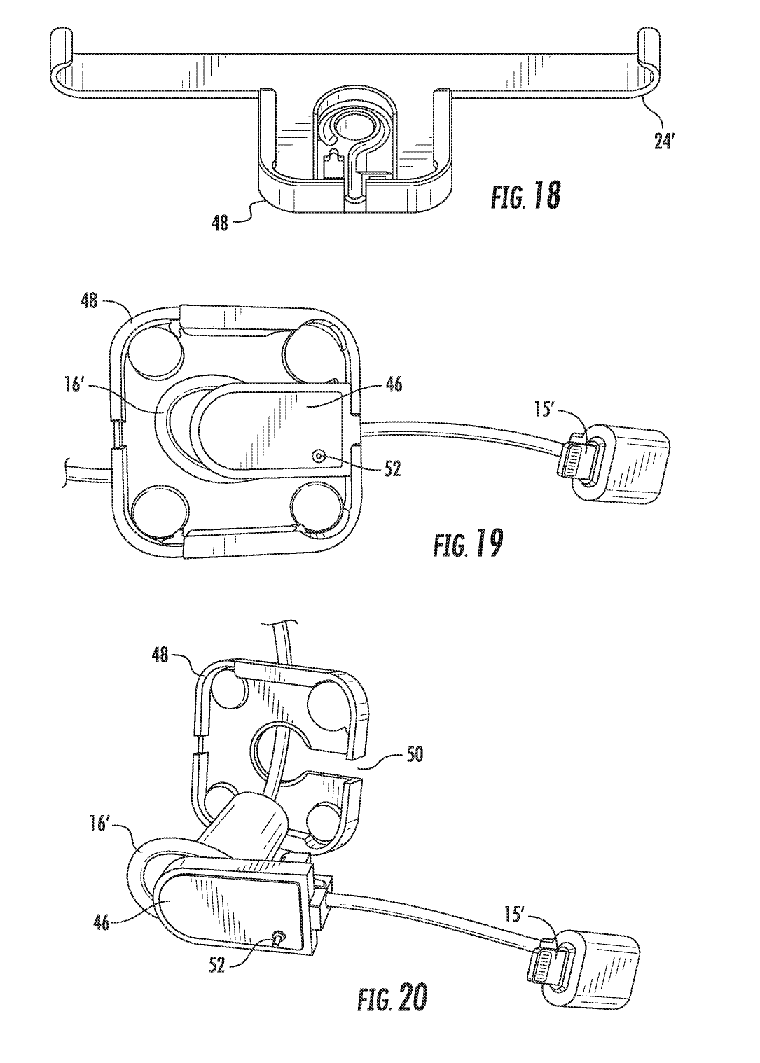

In one embodiment, FIGS. 15-18 show that the sensor 12′ may also include one or more modular components. In this regard, the sensor 12′ may include one or more bracket arms 24′ as discussed above, a cap member 42, a swivel 46, and a sensor base 48. The cap member 42 and the sensor base 48 may separate components and attached to one another or may be an integrally formed component. In either case, a gap may be defined between the lower surface of the cap member 42 and an upper surface of the sensor base 48 for reasons to be described below. Moreover, the sensor base 48 may include a slot 50 for receiving a portion of the cable 20′ therethough. The adapter cable 16′ and cable 20′ may be connected to the swivel 46 such that engagement of the swivel with the sensor base 48 connects the cables to the sensor base. The swivel 46 may be configured to be inserted through an opening defined in each of the cap member 42 and the sensor base 48 (see, e.g., FIG. 17). In one example, the swivel 46 allows for rotational movement between the sensor 12′ and the cable 20′. The swivel 46 may also at least partially engage the item of merchandise 14 when secured thereto. Where the adapter cable 16′ and cable 20′ are separate cables, the swivel 46 may include a slip ring or like electrical connector for electrically connecting the cables while allowing rotation therebetween. In addition, FIGS. 19-20 show that the swivel 46 may include a sensing device 52, such as a pressure or plunger switch, for sensing removal of the item of merchandise 14 from the sensor 12′. The sensing device 52 may be configured to engage a rear surface of the item of merchandise 14 when secured thereto. FIG. 18 shows that the sensor base 48 is configured to receive the bracket arm 24′, such as in a sliding engagement. For example, the engagement may be by way of a dovetail configuration and may be secured in a snap or friction fit connection. When the bracket arm 24′ is secured to the item of merchandise 14 and engaged with the sensor base 48, the item of merchandise is secured to the sensor 12′. The configuration of the bracket arm 24′ and sensor base 48 allows for a “quick-release” feature whereby items of merchandise 14 may be readily removed for remerchandising or daily removal.

In some embodiments, the bracket arm 24′ may be configured to generate a security signal, such as an audible and/or a visible alarm. For example, the bracket arm 24′ may include an alarm mechanism, such as a piezoelectric transducer, for generating an audible alarm in response to a security event. The dimensions of the bracket arm 24′ may be modified accordingly to provide space for housing an alarm mechanism. Similarly, the sensor 12′ may house an alarm mechanism. Thus, the bracket arm 24′ and/or sensor 12′ may be configured to generate a security signal. In one example, the cap member 42 and sensor base 48 may house an alarm mechanism therein. In order to provide such functionality, the bracket arm 24′ and/or sensor 12′ may also include a power source and circuitry/printed circuit board in communication with the alarm mechanism. In some instances, the swivel 46 may include one or more electrical contacts that are electrically connected to one or more conductors in the cable 20′. Likewise, the bracket arm 24′ and/or sensor 12′ may include one or more electrical contacts that are configured to mate with and electrically connected to the contacts of the swivel 46. When in contact with one another, the electrical contacts allow for a sense loop to be formed with the bracket arm 24′ and/or sensor 12′. For instance, should the cable 20′ be cut or disconnected, the sensor 12′ removed from the swivel 46, or the bracket arm 24′ removed from the item of merchandise, an interruption in the sense loop may occur resulting in the bracket arm 24′ and/or the sensor 12′ generating a security signal.

The modularity of the sensor 12′ allows for convenient removal of the sensor and the item of merchandise 14 by authorized personnel for daily removal purposes or for relocating an item of merchandise to another display location. Moreover, the modularity of the sensor 12′ allows the sensor to be of smaller size, such as for fitting through an opening defined in the support surface 44. For instance, as shown in FIG. 14, the recoiler 22′ may be positioned below the support surface 44, while the base 18′ may be supported on the support surface. Thus, a larger opening is not required to pass the sensor 12′ through the support surface.

In some cases, the length of the adapter cable 16′ may be adjustable for accommodating differently sized items of merchandise 14. For example, FIGS. 19-21 show that the length of the adapter cable 16′ between the sensor 12′ and the connector 15′ may be adjusted. In the illustrated embodiment, the adapter cable 16′ may be configured to be routed through the swivel 46, and tension applied to the end of the adapter cable in either direction results in adjustment of the length of the adapter cable 16′. In some cases, a portion of the adapter cable 16′ is wrapped about the swivel 46. Additionally, any “slack” that results from excess adapter cable 16′ being retracted into the sensor 12′ may be received within the gap defined between the cap member 42 and the sensor base 48. Thus, any excess adapter cable 16′ will be obscured from view thereby resulting in no visible excess adapter cable extending between the sensor 12′ and the item of merchandise 14.

The cable 20′ and/or recoiler 22′ may be operably engaged with an alarm mechanism 34, such as a piezoelectric transducer, for generating an audible alarm in response to a security event (see, e.g., FIG. 8). In some cases, security systems 100 may be configured to operably engage the alarm mechanism 34. The base 18′, alarm mechanism 34, or other device operably engaged with the alarm mechanism may include a port 36 that is configured to facilitate communication with a key. For example, the port 36 may facilitate wireless communication with a key for arming or disarming the security system 100. In one embodiment, the key is an infrared key configured to arm/disarm the alarm mechanism 34 with a unique identifying code. In some embodiments, the key is similar to the IR and IR2 keys manufactured by InVue Security Products Inc.

Various sensing techniques may be employed for determining whether the cables 16′, 20′ have been cut or removed from the sensor 12′ in an unauthorized manner. For example, the cables 16′, 20′ may include a pair of electrical conductors that define a sense loop therethrough. Thus, should the sense loop be interrupted (e.g., by cutting or shorting the cable), the alarm mechanism 34 may detect the interruption and generate an alarm signal (e.g., an audible and/or a visible alarm). In addition, should the item of merchandise 14 and bracket arm 24′ be removed without first disarming the alarm mechanism 34, the sensing device 52 may be activated to indicate a security event has occurred.

In one embodiment, the security system 10, 100 is configured to interact with the item of merchandise 14. In this regard, in some cases the item of merchandise 14 may be configured to receive and provide various types of information. For instance, one or more of items of merchandise may be configured to communicate with a central controller 54 which may be contained within the alarm mechanism 34 or otherwise in communication with the alarm mechanism (see, e.g., FIG. 8). The central controller 54 may be embodied in many different forms, such as a module configured to be connected to the alarm mechanism 34 or a separate computing system. The central controller 54 may be positioned remotely from the item of merchandise 14. For example, the central controller 54 and one or more items of merchandise 14 may be configured to be paired to one another (e.g., via Bluetooth communication). In some instances, the item of merchandise 14 may include a software application that enables communication with the central controller 54 and for receiving instructions from the central controller. When paired, the central controller 54 may be configured to communicate with the item of merchandise 14 to cause the item of merchandise to generate a security signal in response to a security event. Thus, the item of merchandise 14 may be configured to generate its own alarm in response to a security event. The alarm on the item of merchandise 14 may be armed and/or disarmed via communication with the central controller 54 and/or a key as discussed above. The central controller 54 may also be configured to initiate a “kill switch” for inactivating the item of merchandise 14 in response to a security event. The kill switch may be configured to disable or otherwise render the item of merchandise 14 inoperable. For example, U.S. Publication No. 20170148288, entitled Security System with Kill Switch Functionality and filed on Jul. 16, 2014, and now U.S. Pat. No. 10,002,506, which is incorporated herein in its entirety by reference, includes examples of a “kill switch”, which may be incorporated in embodiments of the present invention.

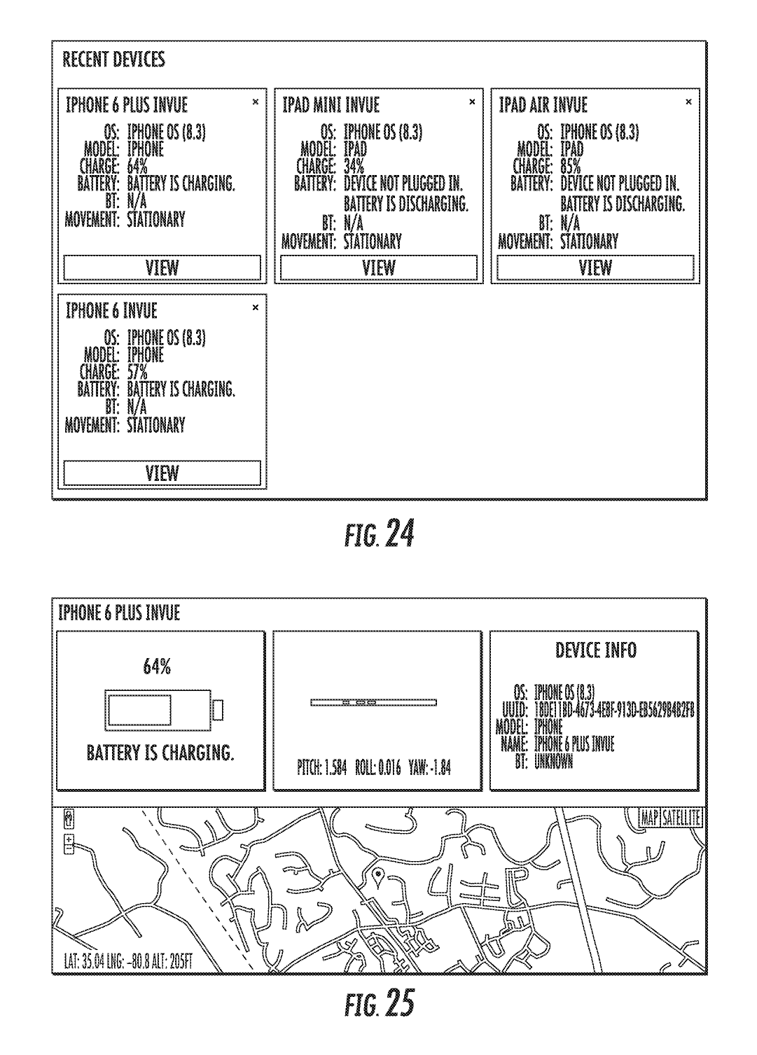

In some embodiments, one or more items of merchandise 14 may be configured to communicate with the central controller 54 using other types of communications protocols, such as Wi-Fi or cellular communication. Where Wi-Fi communication is employed, various information regarding the item of merchandise 14 may be obtained, such as the type of operating system of the item of merchandise, the model of the item of merchandise, the identification of the item of merchandise, the operating status of the item of merchandise (e.g., a battery charge remaining on the item of merchandise), and whether the item of merchandise is moving (see, e.g., FIG. 24). FIG. 24 also demonstrates that the central controller 54 may monitor a plurality of items of merchandise 14 in some cases and that the information may be configured to be displayed at the central controller 54 or at a designated display location, such as a remote computer or display. FIG. 25 shows that additional information may be provided to the central controller 54 or at a designated display location, such as visual information regarding the battery charge, the actual position of the item of merchandise (including pitch, roll, and yaw coordinates), detailed information regarding the operating system, UUID, model, and name of the item of merchandise, as well as the actual location of the item of merchandise on a map. Thus, any information that the item of merchandise 14 may be aware of may be obtained and could be used for interactivity reporting.

In other embodiments, the central controller 54 and one or more items of merchandise 14 may be configured to communicate via cellular communications. In this case, the central controller 54 may be configured to track the location of the item of merchandise 14 in response to a security event. For example, U.S. Provisional Application No. 62/047,953, entitled Sensor Powered by Item of Merchandise for Retail Security and filed on Sep. 9, 2014, and International Application No. PCT/US2015/041451, entitled Sensor Powered by Item of Merchandise for Retail Security and filed on Jul. 22, 2015, each of which is incorporated herein in its entirety by reference, includes examples of tracking an item of merchandise, which may be incorporated in embodiments of the present invention. The item of merchandise 14 may be tracked so that the appropriate authorities may be contacted for locating the item of merchandise and apprehending the thief.

In some embodiments, a beacon or like device may be employed to locate an item of merchandise 14 following a security event. For example, a radiofrequency beacon could be employed to communicate with the item of merchandise 14 and/or sensor 12, 12′ so that a more definitive location of the item of merchandise may be realized in close proximity. In other cases, Bluetooth or like communication could be used to pinpoint the location of the item of merchandise 14 following a security event, such as by identifying a specific identification number or MAC address of the item of merchandise.

In some embodiments, the central controller 54 is configured to communicate with any number of items of merchandise 14 secured by a variety of security systems 10, 100, such as one or more of the security systems described above.

The foregoing has described one or more embodiments of security systems for securing an item of merchandise from theft or unauthorized removal. Although various embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

That which is claimed is:

1. A security system for securing an item of merchandise from theft, comprising:
an item of merchandise on display in a retail store, the item of merchandise comprising a software program for obtaining data from the item of merchandise and for generating a security signal in response to a security event; and
a central controller configured to communicate with the item of merchandise using a wireless communication protocol for obtaining the data.

2. The security system of claim 1, wherein the central controller is located remotely from the item of merchandise.

3. The security system of claim 1, wherein the central controller is a computing system.

4. The security system of claim 1, wherein the item of merchandise is configured to be paired to the central controller.

5. The security system of claim 1, wherein the central controller is configured to remotely disarm the item of merchandise.

6. The security system of claim 1, wherein the central controller is configured to communicate with the item of merchandise for disabling the item of merchandise in response to a security event.

7. The security system of claim 1, further comprising a plurality of items of merchandise, wherein the central controller is configured to communicate with each of the plurality of items of merchandise.

8. The security system of claim 1, wherein the central controller is configured to communicate with the item of merchandise using Wifi communication protocol.

9. The security system of claim 1, wherein the central controller is configured to communicate with the item of merchandise using Bluetooth communication protocol.

10. The security system of claim 1, wherein the central controller is configured to communicate with the item of merchandise using cellular communication protocol.

11. The security system of claim 1, wherein the data comprises an operating system of the item of merchandise.

12. The security system of claim 1, wherein the data comprises a model of the item of merchandise.

13. The security system of claim 1, wherein the data comprises a unique identifier of the item of merchandise.

14. The security system of claim 1, wherein the data comprises an operating status of the item of merchandise.

15. The security system of claim 1, wherein the data comprises data regarding movement of the item of merchandise.

16. The security system of claim 1, wherein the central controller comprises a display for displaying information regarding the data and the item of merchandise.

17. The security system of claim 1, wherein the central controller is configured to track a location of the item of merchandise in response to the security event.

18. The security system of claim 1, further comprising a beacon configured to wirelessly communicate with the item of merchandise and to facilitate locating the item of merchandise.

19. The security system of claim 1, wherein the central controller is configured to communicate directly with the item of merchandise for interacting with the item of merchandise.

20. A method for securing an item of merchandise from theft, the method comprising:
in response to a security event, obtaining data from an item of merchandise on display in a retail store using a software program on the item of merchandise;
in response to the security event, generating a security signal using the software program on the item of merchandise; and
communicating the data from the item of merchandise to a central controller using a wireless communication protocol.
